(19) United States
(12) Patent Application Publication
(10) Pub. No.: US 2007/0223834 A1
(43) Pub. Date: Sep. 27, 2007

(54) Method for small detail restoration in digital images

(75) Inventors: Surapong Lertrattanapanich, Irvine, CA (US); Yeong-Taeg Kim, Irvine, CA (US); Zhi Zhou, Corona, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/388,632

(22) Filed: Mar. 23, 2006

(51) Int. Cl. G06K 9/40

(52) U.S. Cl. 382/263

(57) ABSTRACT

A small detail restoration (SDR) system implements an SDR method for processing digital images, especially in DTV applications prior to image resampling process in a scaler unit. The SDR system performs three image processing functions: detail extraction, smoothness checking, and small detail detection on an input image. The results of the three processing functions are combined, amplified and added back to original image to obtain the final resulting output image. The SDR method is applied in the texture or small detail area of image while the strong edge area is not enhanced. For example, in DTV applications, the SDR method is suitable for enhancing the digital image prior to image resampling process in the scaler unit.

### FIELD OF THE INVENTION

The present invention relates to digital image processing, and more particularly small detail restoration in images.

### BACKGROUND OF THE INVENTION

In digital image processing, image enhancement techniques are usually used so that the result perceptually looks better than the original. A small detail restoration (SDR) method is the generalized version of popular image enhancement techniques called “unsharp masking.” The unsharp masking is one of the basic tools in printing and publishing industry. The unsharp masking result is basically the addition between original image and the amplified high pass filtered of the original image. However, conventional unsharp masking still lacks many protection mechanisms to be suitable for digital television (DTV) applications. For example, not only are strong edges, texture, and small detail areas enhanced, but the noisy areas are also boosted. Moreover, there is not any detection to classify which area is good for enhancement and which is not. Further, it is known that if the enhancement is applied on the strong edge area, it will also introduce the shooting artifact. On the other hand, the enhanced texture or small detail areas do not have the shooting artifact.

### SUMMARY OF THE INVENTION

An object of the present invention is to provide a small detail restoration (SDR) method for processing digital images especially in DTV applications prior to image resampling process in a scaler unit. The SDR method includes three processes: detail extraction, smoothness checking, and small detail detection. Preferably, these processes are performed essentially in parallel. After the results from the three processes are obtained, their product is amplified and added back to original image to obtain the final resulting output image. Detail enhancement is selectively applied more on small detail and texture areas and less on the strong edge and noisy areas.

An SDR system implementing an SDR method according to the present invention improves over conventional unsharp masking methods. First, a noise reducer helps control the level of noise of the original image while preserving the sharp edges as well as some texture and small detail areas. In addition, unlike conventional unsharp masking, an SDR filter is used that can be either a high-pass or a band-pass filter with different selections of peak frequencies. Further, the level of enhancement is noise adaptive when the prior knowledge of noise level is available. And, a smoothness checker classifies between the noise area and the texture or small detail area to some extents, and prevents noise amplification. The SDR system is simple and effective for distinguishing between the small detail or texture area and the strong edge area. Therefore, the proper processing can be applied in each area effectively.

In one example, the small detail restoration (SDR) method is provided for image enhancement only in the texture or small detail area of image while the strong edge area is not enhanced. For example, in DTV applications, the SDR method is suitable for enhancing the digital image prior to image resampling process in the scaler unit.

These and other features, aspects and advantages of the present invention will become understood with reference to the following description, appended claims and accompanying figures.

### BRIEF DESCRIPTION OF THE DRAWINGS

FIG. 1 shows a block diagram of an SDR system, according to an embodiment of the present invention.

FIG. 2 shows a block diagram of an embodiment of the noise reducer of FIG. 1, according to an embodiment of the present invention.

FIG. 3 shows a block diagram of an embodiment of the smoothness checker of FIG. 1, according to an embodiment of the present invention.

FIG. 4 shows a drawing of an example set of neighbor pixels surrounding a considered pixel along with four directions used in the 4-direction sign change counter of FIG. 3, according to an embodiment of the present invention.

FIG. 5 shows a block diagram of an embodiment of the small detail detector of FIG. 1, according to an embodiment of the present invention.

FIG. 6 shows an example set of neighbor pixels surrounding the considered pixel which is used in calculating the variance in the variance calculator of FIG. 5, according to an embodiment of the present invention.

### DETAILED DESCRIPTION OF THE INVENTION

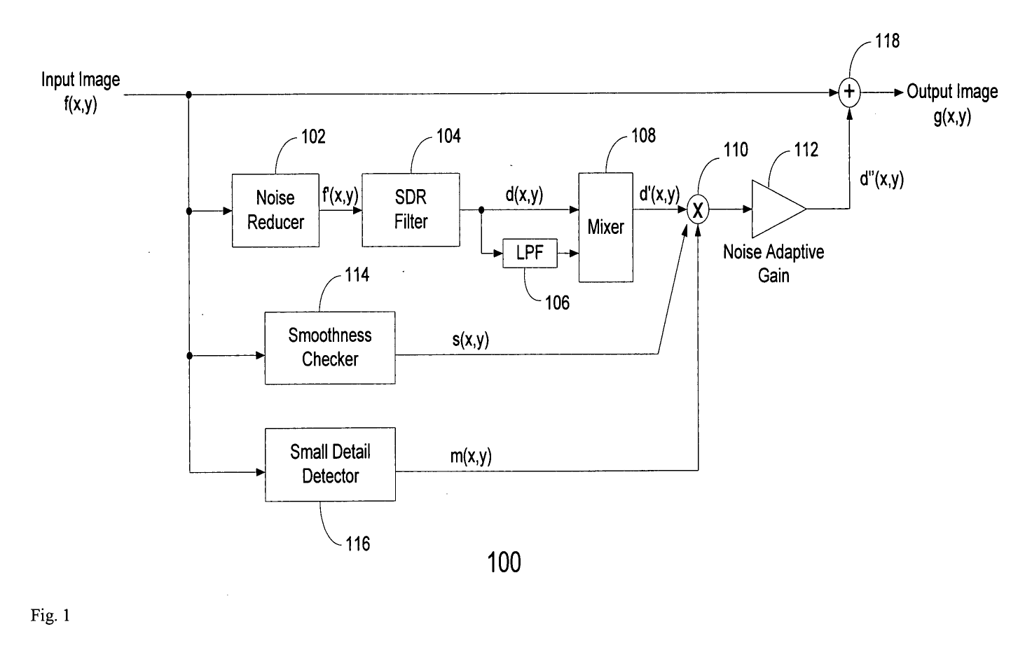

FIG. 1 shows a block diagram of a small detail restoration (SDR) system 100 which implements an SDR method, according to an embodiment of the present invention. Suppose that the input image f(x,y) is of width M and height N, i.e. size M×N, where the coordinate (x,y) represents the considered pixel in the image at column x and row y. The system 100 applies a SDR method, according to the present invention, to the input image f(x,y) of size M×N which results in the output image g(x,y) of the same size.

The input image f(x,y) is processed by essentially three main processes (functions) in system 100: (1) detail extracting performed by a cascade of noise reducer (remover) 102, small detail restoration (SDR) filter 104, low pass filter (LPF) 106 and mixer 108, (2) smoothness checking performed by smoothness checker 114, and (3) small detail detecting performed by small detail detector 116. Once the results from the three processes are calculated, their product is obtained at a junction 110, which product is then amplified in an amplifier 112 and added back to the original image f in a junction 118, to obtain the final output image g.

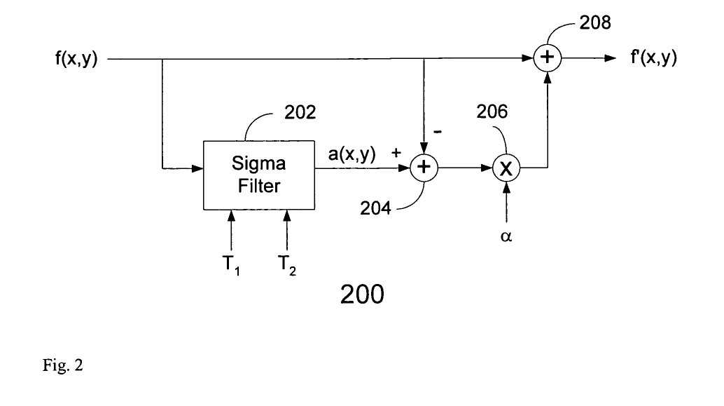

Specifically, the input image f(x,y) is passed to the noise reducer 102 so that a resulting noise reduced output f′(x,y) contains less noise than the original input image f(x,y) while sharp edges still remains sharp. The said noise reducer 102 will be discussed later in the description of FIG. 2. Then, the image f′(x,y) is passed to a small detail restoration filter 104 to obtain detail information d(x,y). The SDR filter 104 comprises e.g. a two-dimensional (2-D) finite impulse response (FIR) type that can be e.g. 5×5 or 7×7 (in height×width). The SDR filter can comprise e.g. high-pass or band-pass filter depending on the designed peak frequency. The peak frequency is the frequency which provides the highest magnitude response of the designed filter. In the example herein, SDR filters are designed to have circularly symmetric frequency response with different peak frequencies. In addition, the zeroth moment of SDR filter must be preserved, i.e. the summation of all filter coefficients must equal zero. An example from a set of suitable SDR filters has a peak frequency of 0.98π radian and a frequency response h expressed in relation (1)

$$h ( x , y ) = \frac{1}{1024} [ \begin{matrix}- 10 & - 40 & - 60 & - 40 & - 10 \\ - 40 & - 42 & - 4 & - 42 & - 40 \\ - 60 & - 4 & 784 & - 4 & - 60 \\ - 40 & - 42 & - 4 & - 42 & - 40 \\ - 10 & - 40 & - 60 & - 40 & - 10\end{matrix} ] . \qquad ( 1 )$$

The resulting output detail d(x,y) from SDR filter 104 is further low-pass filtered using a low pass filter (LPF) 106, wherein the resulting output of the LPF 106 is mixed with the detail d(x,y) using the mixer 108 to generate mixed detail d′(x,y). The LPF 106 comprises, in one example, a simple 3×3 FIR filter whose coefficients are represented in relation (2):

$$LPF ( x , y ) = \frac{1}{1024} [ \begin{matrix}50 & 90 & 50 \\ 90 & 464 & 90 \\ 50 & 90 & 50\end{matrix} ] . \qquad ( 2 )$$

The mixer 108 performs the linear combination between detail d(x,y) and its corresponding low pass filtered value from the LPF 106, with the mixing coefficient τ. In one example, the mixed detail d′(x,y) can be expressed by relation (3):
d′(x,y)=τ·d(x,y)+(1−τ)·LPF(x,y)*d(x,y), (3)
wherein symbol “*” in relation (3) is the 2-D discrete convolution operator and symbol “.” is the multiplication operator.

In parallel with the above detail extraction process, the input image f(x,y) is passed through smoothness checker 114 and small detail detection 116 to obtain, respectively, the smoothness coefficient s(x,y) and the small detail map m(x,y). Next, the product of the mixed detail d′(x,y), the smoothness coefficient s(x,y), and the small detail map m(x,y) are obtained by the multiplier junction 110. The resulting output from the junction 110 is then amplified by the noise adaptive gain unit 112 to generate output d″(x,y). In one example, the gain parameter in the 112 is GAINSDR and the noise level σ of input image is known, wherein the output d″(x,y) of the unit 112 can be expressed by relation (4) as:

$${d}^{″} ( x , y ) = {GAIN}_{SDR} \cdot max ( 0 , min ( 1 , \frac{{T}_{2} - σ}{{T}_{2} - {T}_{1}} ) ) \cdot {d}^{′} ( x , y ) \cdot s ( x , y ) \cdot m ( x , y ) , \qquad ( 4 )$$

where T₁ and T₂ are the preset thresholds (T₁<T₂).

At the final step, the output d″(x,y) is added back to the original input image f(x,y) by the adder junction 118 to obtain the output image g(x,y).

An example embodiment of the noise reducer 102 is shown as the noise reducer 200 in FIG. 2. In the noise reducer 200, first, the input image f(x,y) is filtered by a sigma filter 202 to obtain filtered signal a(x,y). Then, the signal a(x,y) is subtracted from the original input image f(x,y) using a subtractor 204. The subtraction result is multiplied by a noise reduction coefficient α (0<α≦1) using a multiplier 206. Finally, the multiplication result is added back to the original image f(x,y) to obtain said noise reduced image f′(x,y). In one example, the noise reduced image f′(x,y) is expressed by relation (5)
f′(x,y)=f(x,y)+α·(a(x,y)−f(x,y)). (5)

The sigma filter 202 is a type of nonlinear edge-preserving noise filtering. Let a set [symbol] of neighbors of the considered pixel f(x,y) be defined by the pixels (excluding the considered pixel) within window of preset size whose center is at the considered pixel f(x,y). The sigma filtered output a(x,y) can be expressed by relation (6):

$$a ( x , y ) = \frac{f ( x , y ) + {\sum }_{η ∈ ℵ} η \cdot w ( η )}{1 + {\sum }_{η ∈ ℵ} w ( η )} , \qquad ( 6 )$$

wherein the weight w(η) associated with neighbor ηε [symbol] of considered pixel f(x,y) is represented by relation (7):

$$w ( η ) = max ( 0 , min ( 1 , \frac{\vert f ( x , y ) - η \vert - {T}_{2}}{{T}_{1} - {T}_{2}} ) ) . \qquad ( 7 )$$

The parameters T₁ and T₂ in relation (7) are the preset thresholds (T₁<T₂).

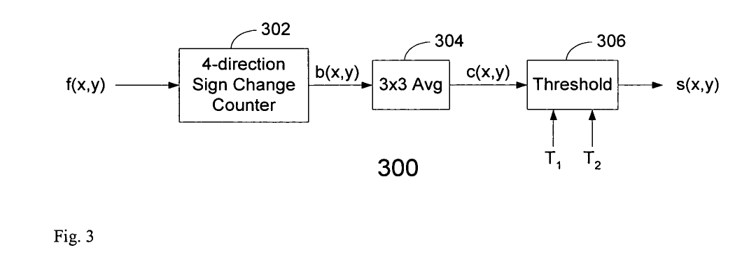

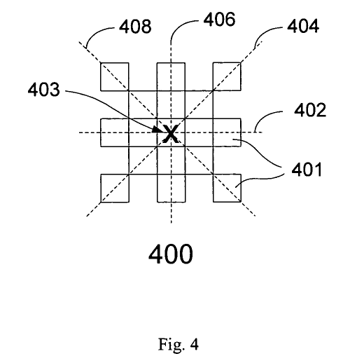

An example embodiment of the smoothness checker 114 is shown as the smoothness checker 300 in FIG. 3. The smoothness checker unit 300 yields the smoothness coefficient s(x,y) corresponding to the considered pixel f(x,y). The smoothness coefficient s(x,y) represents the level of smoothness within neighborhood of the considered pixel f(x,y). First, the number of sign changes b(x,y) of the considered pixel f(x,y) is obtained using a 4-direction sign change counter module 302. The module 302 performs sign change counting separately in four directions 402, 404, 406, and 408 as shown by example in FIG. 4. As such, FIG. 4 shows a drawing of an example set of neighbor pixels 401 surrounding the considered pixel 403 (i.e., f(x,y)) marked by symbol X along with said four directions. Each direction includes 5 pixels and the considered pixel which is located at the center. The module 302 sums up all calculated sign changes in each direction to obtain the number of sign changes b(x,y).

Suppose that an ordered set A of five pixels in the certain direction is given by A=[a₀ a₂ a₃ a₄] A set B=[b₀₁ b₁₂ b₂₃ b₃₄] of signs between adjacent pixels is first calculated, where bᵢⱼ is defined by relation (8):

$${b}_{ij} = \{ \begin{matrix}1 & if {a}_{1} - {a}_{0} > 0 \\ 0 & if {a}_{1} - {a}_{0} == 0 \\ - 1 & if {a}_{1} - {a}_{0} < 0.\end{matrix} \qquad ( 8 )$$

The number of sign changes SA associated with the direction specified by set A can be expressed by relation (9):
s_{A}=Pred(b₀₁·b₁₂==−1)+Pred(b₁₂·b₂₃==−1)+Pred(b₂₃·b₃₄==−1), (9)

wherein the function Pred is the predicate function defined by relation (10):

$$Pred ( x ) = \{ \begin{matrix}1 & if x == TRUE \\ 0 & if x == FALSE .\end{matrix} \qquad ( 10 )$$

Once the sum of the number of sign changes b(x,y) of the whole image is calculated, it is averaged within its 3×3 neighborhood window in an averaging unit 304 (FIG. 3) to obtain the average c(x,y). Then, the result c(x,y) is passed through a thresholding unit 306 with the preset thresholds T₁ and T₂ (T₁<T₂) and preset offset 0≦β<1 to obtain said resulting smoothness coefficient s(x,y). In one example, the smoothness coefficient s(x,y) is calculated according to relation (11):

$$s ( x , y ) = β + ( 1 - β ) \cdot max ( 0 , min ( 1 , \frac{c ( x , y ) - {T}_{2}}{{T}_{1} - {T}_{2}} ) ) . \qquad ( 11 )$$

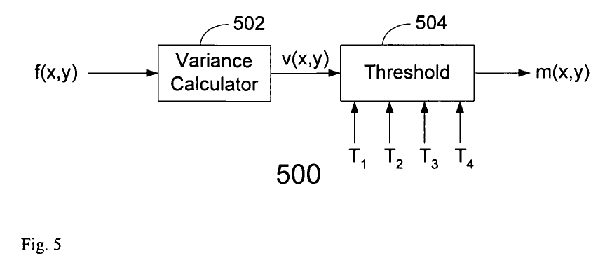

An example embodiment of the small detail detector 116 is shown as the small detail detector 500 in FIG. 5. The input to detector 500 is the considered pixel f(x,y) and the output of detector 500 is a small detail map m(x,y) ranging between e.g. 0 and 1. The value of the map m(x,y) indicates the probability of the considered pixel f(x,y) to be in the small detail region. The map m(x,y) is used to control the level of enhancement of in the small detail or texture area.

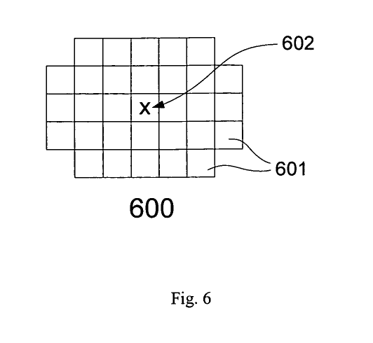

First, the window 600 of pixels 601 whose center is the considered pixel f(x,y) 602 marked by symbol X (FIG. 6) is constructed. Then, a variance calculator 502 (FIG. 5) obtains the approximated variance v(x,y) of the considered pixel f(x,y). Let set W be the set of all pixels (including the considered pixel f(x,y)) within the window 600, wherein the explicit expression used in the variance calculator 502 is defined by example relation (12):

$$v ( x , y ) = \frac{1}{K} {\sum }_{w ∈ W} \vert w - μ \vert , \qquad ( 12 )$$

where K and μ are, respectively, the number of elements in the set W and the sample mean value of all elements in the set W.

Next, the approximated variance v(x,y) is input to a thresholding unit 504 to obtain the resulting output small detail map m(x,y). The thresholding unit 504 is noise adaptive and also incorporates the coring operation altogether. Let the parameter c be the coring parameter and σ be the known noise level of the input image. Given two preset threshold parameters T₁ and T₂ (T₁<T₂), the explicit expression for the small detail map m(x,y) using this unit 504 is given by example relation (13):

$$m ( x , y ) = \{ \begin{matrix}\frac{v ( x , y ) - {t}_{1}}{{t}_{2} - {t}_{1}} & if {t}_{1} < v ( x , y ) < {t}_{2} \\ 1.0 & if {t}_{2} \leq v ( x , y ) \leq {T}_{3} \\ \frac{v ( x , y ) - {T}_{4}}{{T}_{3} - {T}_{4}} & if {T}_{3} < v ( x , y ) < {T}_{4} \\ 0 & otherwise ,\end{matrix} \qquad ( 13 )$$

where the adaptive threshold parameters t₁ and t₂ are defined by relation set (14):
t₁=c+σ·T₁
t₂=c+ρ·T₂

with the constraint that 0<t₁<t₂≦T₃<T₄.

An SDR system implementing an SDR method according to the present invention improves over conventional unsharp masking methods. First, a noise reducer helps control the level of noise of the original image while preserving the sharp edges as well as some texture and small detail areas. In addition, unlike conventional unsharp masking, an SDR filter is used that can be either a high-pass or a band-pass filter with different selections of peak frequencies. Further, the level of enhancement is noise adaptive when the prior knowledge of noise level is available. And, a smoothness checker classifies between the noise area and the texture or small detail area to some extents, and prevents noise amplification. The SDR system is simple and effective for distinguishing between the small detail or texture area and the strong edge area. Therefore, the proper processing can be applied in each area effectively.

The small detail restoration (SDR) system according to the present invention implements an SDR method for processing digital images, especially in DTV applications prior to image resampling process in a scaler unit. The SDR system performs three image processing functions: detail extraction, smoothness checking, and small detail detection on an input image. The results of the three processing functions are combined, amplified and added back to original image to obtain the final resulting output image. The SDR method is applied in the texture or small detail area of image while the strong edge area is not enhanced. For example, in DTV applications, the SDR method is suitable for enhancing the digital image prior to image resampling process in the scaler unit.

The present invention has been described in considerable detail with reference to certain preferred versions thereof; however, other versions are possible. Therefore, the spirit and scope of the appended claims should not be limited to the description of the preferred versions contained herein.

What is claimed is:

1. A small detail restoration method for processing an input digital image, comprising the steps of:
performing detail extraction on the input image to obtain detail information;
performing smoothness checking on the input image to obtain smoothness information;
performing small detail detection to obtain small detail information;
combining the detail information, the smoothness information and small detail information with the input image to generate an output image with small detail restored.

2. The method of claim 1 wherein the step of performing detail extraction further includes the steps of performing noise reduction to generate noise reduced image.

3. The method of claim 2 wherein the step of performing detail extraction further includes the steps of performing noise reduction to control the level of noise of the input original image while preserving the sharp edges as well as texture and small detail areas.

4. The method of claim 3 wherein the step of performing detail extraction further includes the steps of using an SDR filter to filter the noise reduce image to generate said detail information.

5. The method of claim 4 wherein the SDR filter comprises a band pass filter.

6. The method of claim 4 wherein the SDR filter comprises a high pass filter.

7. The method of claim 4 wherein step of performing detail extraction further includes the steps of performing low pass filtering of the detail information to generate filtered detail information.

8. The method of claim 7 further comprising the steps of combining said detail information and the filtered detail information to obtain combined detail information, and then combining the combined detail information, the smoothness information and small detail information with the input image to generate said output image.

9. The method of claim 1 wherein the step of combining further includes the steps of:
generating a product of the detail information, the smoothness information and small detail information;
amplifying the product using an amplifier with noise adaptive gain; and
adding the amplified value to the input image to generate the output image.

10. The method of claim 2 wherein the step of noise reduction further includes the steps of:
filtering the input image to obtain a filtered signal;
subtracting the filtered signal from the input image;
multiplying the subtraction result by a noise reduction coefficient;
adding the multiplication result back to the input image to obtain said noise reduced image.

11. The method of claim 10 wherein the step of filtering further includes the steps of filtering the input image using a non-linear edge-preserving noise filter.

12. The method of claim 1 wherein the step of performing smoothness checking further includes the steps of obtaining smoothness coefficients for the input image, wherein the smoothness coefficients represent level of smoothness within neighborhood of each pixel in the input image.

13. The method of claim 12 wherein the step of obtaining the smoothness coefficients further includes the steps of:
determining the number of sign changes of a pixel in relation to neighboring pixels using a multi-direction sign change counter;
averaging the number of sign changes within a neighborhood window around the pixel; and
thresholding the average to obtain said smoothness coefficients.

14. The method of claim 1 wherein the step of performing small detail detection further includes the steps of obtaining a small detail map indicating the probability of an input image pixel being in a small detail region.

15. The method of claim 14 wherein performing small detail detection further includes the steps of:
approximating the variance of each pixel of the input image; and
thresholding the variance to generate the small detail map.

16. A small detail restoration system for processing an input digital image, comprising:
a detail extractor for performing detail extraction on the input image to obtain detail information;
a smoothness checker for performing smoothness checking on the input image to obtain smoothness information;
a small detail detector for performing small detail detection to obtain small detail information; and
a combiner for combining the detail information, the smoothness information and small detail information with the input image to generate an output image with small detail restored.

17. The system of claim 16 wherein the detail extractor further includes a noise reducer for performing noise reduction to generate noise reduced image.

18. The system of claim 17 wherein the detail extractor further includes a filter for performing noise reduction to generate noise reduced image, to control the level of noise of the input original image while preserving the sharp edges as well as texture and small detail areas.

19. The system of claim 18 wherein the filter comprises an SDR filter to filter the noise reduce image to generate said detail information.

20. The system of claim 19 wherein the SDR filter comprises a band pass filter.

21. The system of claim 19 wherein the SDR filter comprises a high pass filter.

22. The system of claim 19 wherein the detail extractor further includes a low pass filter for low pass filtering of the detail information to generate filtered detail information.

23. The system of claim 22 wherein the detail extractor further includes a mixer for mixing the detail information and the filtered detail information to obtain mixed detail information, wherein said combiner combines the mixed detail information, the smoothness information and small detail information with the input image to generate said output image.

24. The system of claim 16 wherein the combiner comprises:
a multiplier for generating a product of the detail information, the smoothness information and small detail information;
an amplifier for amplifying the product using an amplifier with noise adaptive gain; and
an adder for adding the amplified value to the input image to generate the output image.

25. The system of claim 17 wherein the noise reducer further includes:
a filter for filtering the input image to obtain a filtered signal;
a subtractor for subtracting the filtered signal from the input image;
a multiplier for multiplying the subtraction result by a noise reduction coefficient;
an adder for adding the multiplication result back to the input image to obtain said noise reduced image.

26. The system of claim 25 wherein the filter comprises a non-linear edge-preserving noise filter.

27. The system of claim 16 wherein the smoothness checker further includes the steps of obtaining smoothness coefficients for the input image, wherein the smoothness coefficients represent level of smoothness within neighborhood of each pixel in the input image.

28. The system of claim 27 wherein the smoothness checker comprises:
a sign counter for determining the number of sign changes of a pixel in relation to neighboring pixels using a multi-direction sign change counter;
a averaging unit for averaging the number of sign changes within a neighborhood window around the pixel; and
a thresholder for thresholding the average to obtain said smoothness coefficients.

29. The system of claim 16 wherein the small detail detector generates a small detail map indicating the probability of an input image pixel being in a small detail region.

30. The system of claim 29 wherein the small detail detector further includes:
a variance approximator for approximating the variance of each pixel of the input image; and
a thresholder for thresholding the variance to generate the small detail map.
